(19) United States
(12) Patent Application Publication
(10) Pub. No.: US 2011/0221380 A1
(43) Pub. Date: Sep. 15, 2011

(54) Method and apparatus for providing precise position control for a wide range of equipment applications using SR motors in stepping control mode

(76) Inventors: Ronald A. Johnston, Longview, TX (US); David N. Rowley, Longview, TX (US); Barbara Rowley, Longview, TX (US)

(21) Appl. No.: 13/045,313

(22) Filed: Mar. 10, 2011

Related U.S. Application Data
(60) Provisional application No. 61/312,613, filed on Mar. 10, 2010.

(51) Int. Cl. G05B 19/19

(52) U.S. Cl. 318/685

(57) ABSTRACT

An apparatus is provided for utilizing a Switched Reluctance motor to position and hold a load in a desired position. In operation, one or more switch reluctance (SR) motors are capable of operating in a stepping control mode in a first device. Additionally, a second device is capable of providing precise position control for the first device, while the one or more SR motors are operating in the stepping control mode.

### BACKGROUND

In most motor drive applications, the parameters to determine operations are the speed and torque of the motor. These relate to how fast the motor has to rotate to generate the desired movement of the system that the motor is driving. This system could be the movement of the hook of a crane, the velocity of a wheel, the speed of a fan, or any type of process or control that requires the use of a motor. The second parameter has to do with how much torque is required by the motor to provide this movement. With these parameters in mind, the motors are selected or designed, and the controls are selected or designed to meet these needs. The general operation of a switched reluctance (SR) motor is well known to those experienced in the state of the art.

The SR motor has some distinctive features that allow the precise positioning of and the holding of the motor rotor at a fixed point. The unique construction of stator poles with windings, and the rotor poles without windings, permits a set of poles to line up and hold at a fixed preset position. To rotate the rotor still requires the production of torque and speed, but in this application the control utilizes a decision-making process to move the rotor from pole to pole.

The instant application allows the motor to be utilized in a manner where a precise number of rotations and a precise point of the final rotation is identified and found. In addition, this point can be held until the mechanical brakes or holding device is engaged and the system is shut down. It can then be restarted and held at this point, without movement, even if external forces are applied at the output. In most existing drive controls, there is movement at the load end when the system is first energized if external forces are applied to the motor and drive (e.g. a load suspended on a crane hook will move when the brakes are released until the system generates adequate holding torque).

### SUMMARY

An apparatus is provided for utilizing a switched reluctance (SR) motor to position and hold a load in a desired position. In operation, one or more (SR) motors are capable of operating in a stepping control mode in a first device. Additionally, a second device is capable of providing precise position control for the first device, while the one or more SR motors are operating in the stepping control mode.

### BRIEF DESCRIPTION OF THE DRAWINGS

FIG. 1 shows the overall SR Motor Control Functional Block Diagram for both a parametric (speed torque) and a stepping SR motor.

FIG. 2A shows a simplified representation of a SR motor with a three phase, twelve pole stator and eight pole rotor configuration, and a converter utilizing six electronic switches (IGBT, Transistor, MOSFET, etc.). One set of rotor poles are aligned with a set of stator poles.

FIG. 2B shows a new flux path as phase B is energized. At the start of this process, the rotor poles are not aligned with the stator poles. Therefore a force is exerted on the shown set of rotor poles to align with the energized set of stator poles.

FIG. 2C shows the rotor now aligned with the stator, and the rotor has now moved counterclockwise 15 degrees from its original position. As the procedure continues, the phases energizing in an A, B, C rotation, the rotor will move in a counterclockwise rotation with a 15 degree increment with each phase.

FIG. 3 shows an accounting process whereby the actual rotor position is calculated with a position that includes both number of multi-revolution and the position within a specified revolution.

FIG. 4 shows an accounting process whereby the target rotor position is calculated. This is the desired location for the actual rotor position.

FIG. 5 shows the limits imposed by the various static, dynamic and operator imposed conditions that relate to obtaining a desired path calculation.

FIG. 6 shows an additional set of external/internal conditions that must be accounted for in determining a final set of path commands. It also factors the target rotor position with the current actual rotor position.

FIG. 7 shows the initialization and subsequent decision making process to turn or hold the rotor position.

### DETAILED DESCRIPTION OF THE DRAWINGS

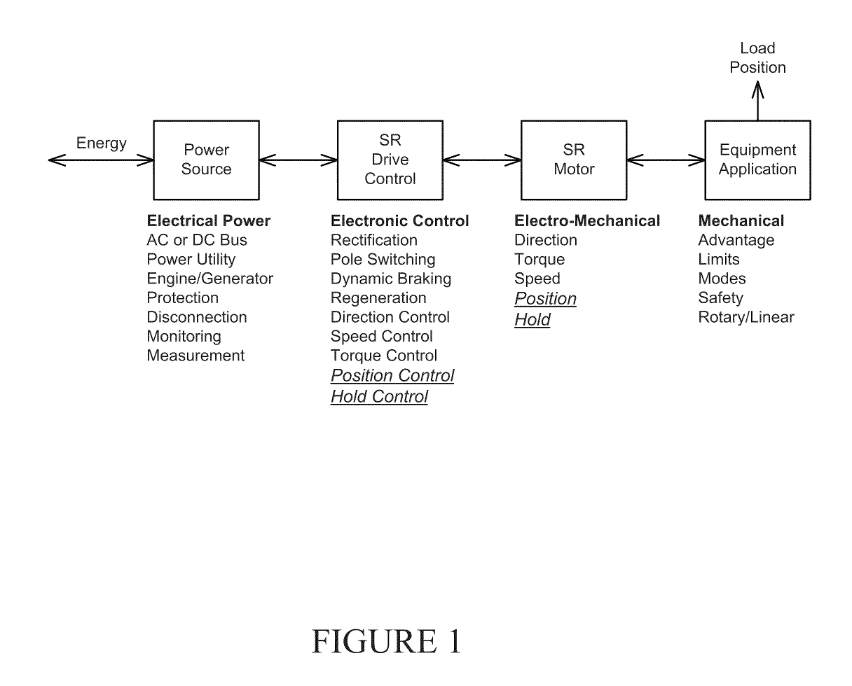

The overall SR Motor Control Functional Block Diagram for both a parametric (speed torque) and a stepping SR motor is shown in FIG. 1. A parametric SR drive control does not provide Position Control or Hold Control as part of the suite of Electronic Control functions. Therefore, the parametric SR Motor does not provide Positioning or Holding Electro-Mechanical functions. This patent provides a scheme by which stepping control is achieved by the Electronic Control of the SR motor

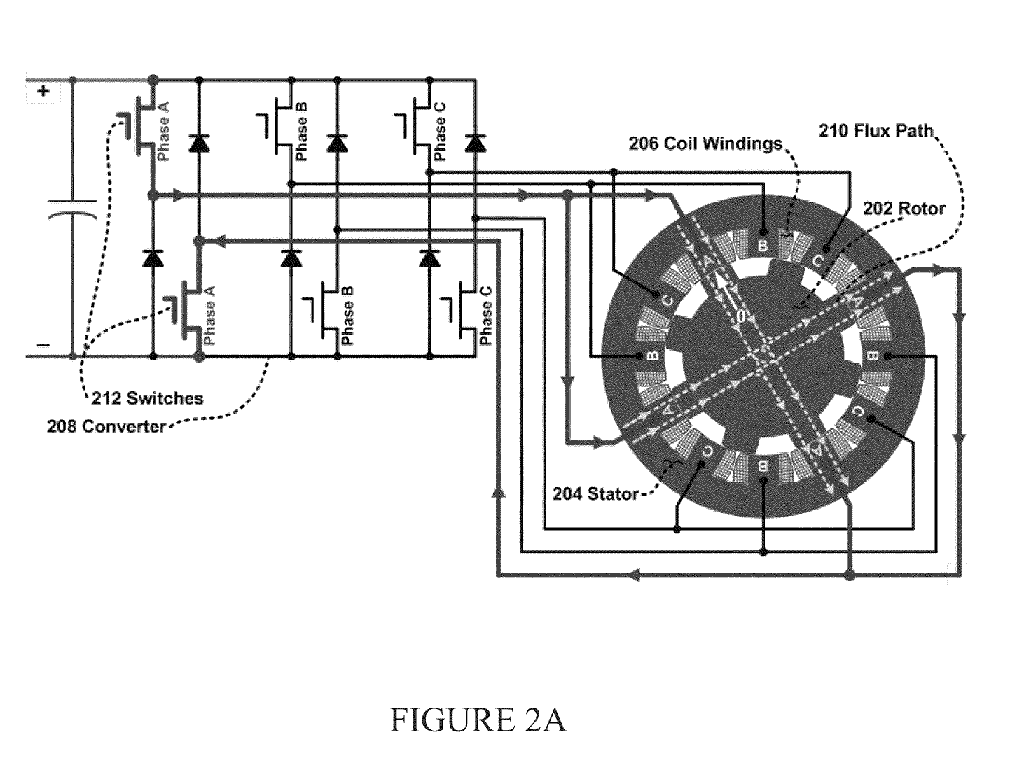

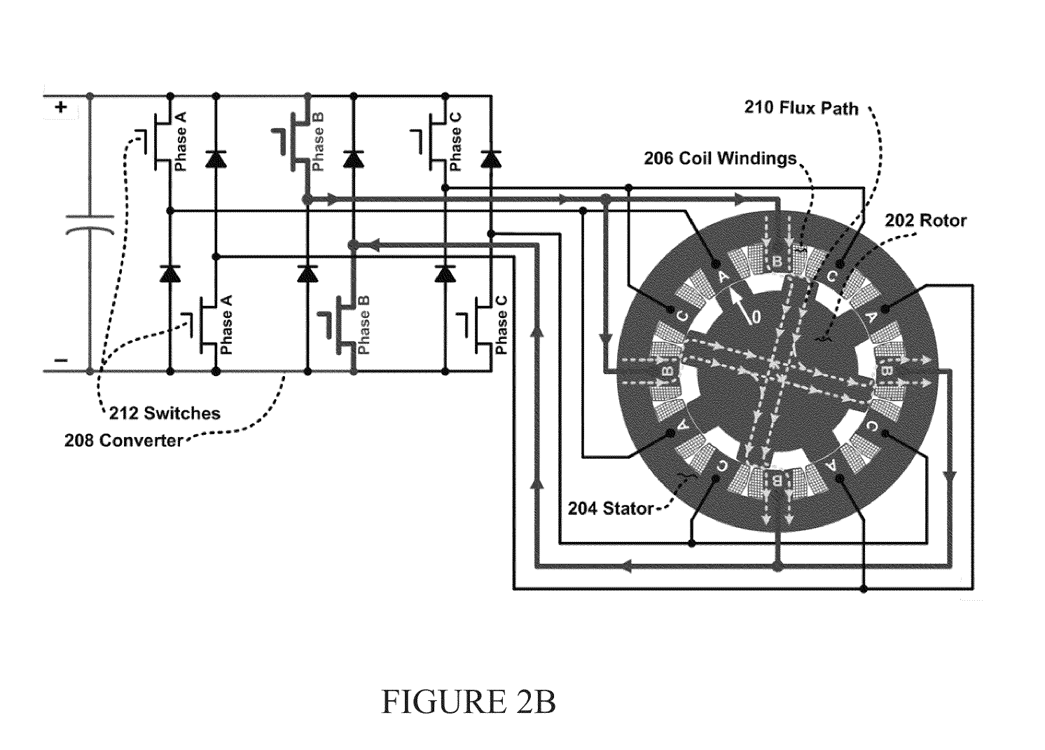

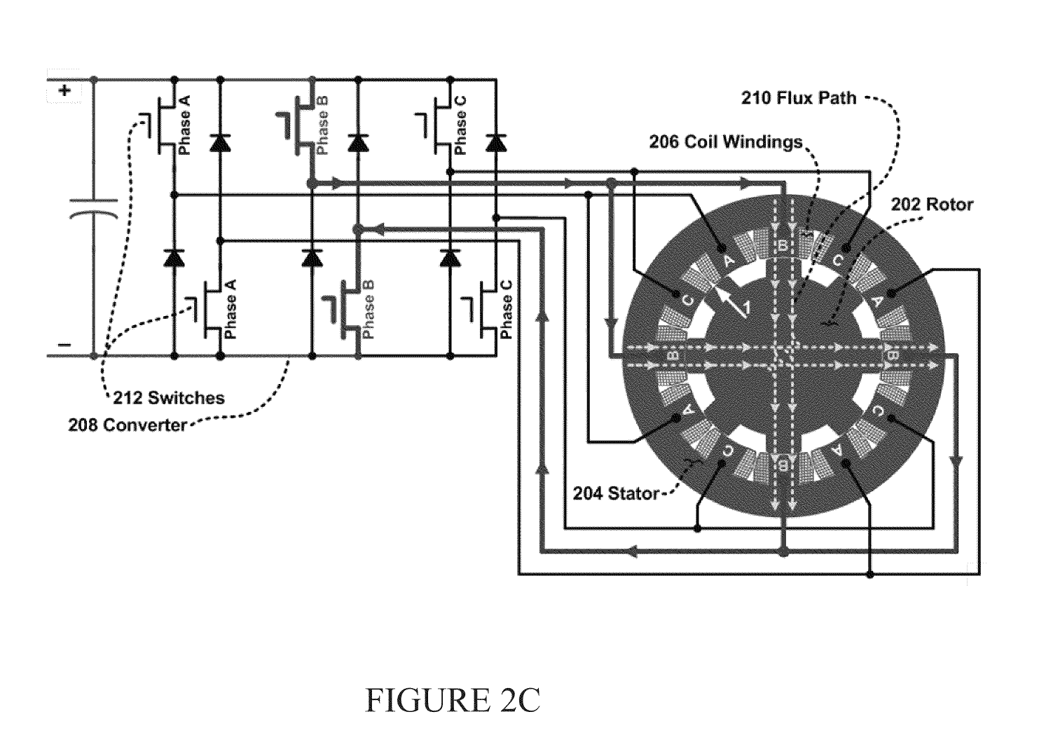

FIG. 2A is a simplified representation of an example SR motor configuration with a three phase, twelve pole stator 204 and an eight pole rotor 202. A converter 208 using six electronic switches 212 (e.g. IGBT, Transistor, MOSFET, etc.) is shown with two switches for each phase and four coil windings 206. Phase A of the converter is on, as indicated by the bold lines showing current direction with arrows. With phase A energized and the rotor 202 in position 0, an electromagnet is formed with magnetic flux paths as indicated simplistically by the light colored flux lines 210. This generates torque, pulling the nearest rotor poles more closely in line with the energized Phase A stator poles, as shown in the diagram.

FIG. 2B shows simplistically how a new flux path 210 is created when phase B 206 coil winding is energized after Phase A. At the start of this transition, the rotor poles 202 are not aligned with the now energized Phase B stator coils 206, and therefore the reluctance against magnetic flux has not reached a minimum. Hence, a force of attraction is exerted on the rotor 202 poles to align them with the recently energized set of stator poles 204, creating a counterclockwise torque on the rotor 202.

FIG. 2C shows the rotor 202 now aligned with the Phase B stator poles by the rotor moving counterclockwise 15 degrees from its original Position 0 to its new Position 1. Rotation occurred until the flux followed the shortest possible path 210 with the lowest possible reluctance. As the procedure continues, the switches 212 energize in a Phase A, Phase B, Phase C sequence, and the rotor will repeatedly move counterclockwise by magnetic attraction in 15 degree increments. In following explanations, these increments are assigned a sequential pole position number.

With respect to FIGS. 2A and 2C, when the rotor poles are aligned with the energized phase stator poles, a monostable state is formed that can be maintained indefinitely with only the current required to balance the load torque while doing no work. The amount of torque generated on the rotor will be a function of the current in the coils, the composition of the stator and rotor (magnetic properties), and the number of coil turns. Furthermore, advancing from phase to phase results in exactly 15 degrees of rotor rotation, which can be designated as pole positions or PP.

The SR motor has some innate distinctive features that allow the precise positioning and holding of the motor rotor at a fixed point. The unique construction of rotor poles without windings or slip rings or commutating bars or brushes, permits a set of poles to line up and hold at a fixed position without heating the rotor and without any limits due to the windings, commutator, or brushes. Incorporating magnetic attraction for torque development means that each phase activation results in a rotor position that is monostable against counter-torque in either direction. These features of SR drives are fully leveraged in this new method of control by stepping.

### Exemplary Embodiment

This embodiment of precise SR motor position control uses SR stepping control, where one step equals one Pole Position (PP) (which, for example, may be 15 degrees in the background example). SR stepping control may include at least five new SR control functions as described below.

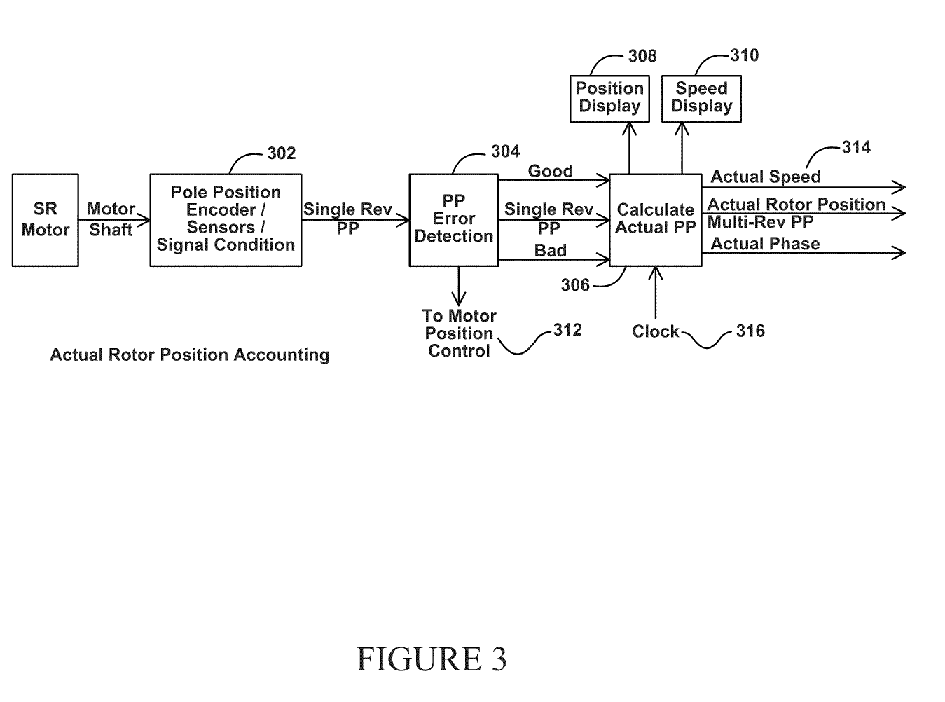

Function 1, the Actual Rotor Position Accounting is shown in FIG. 3.

This process may detect where the rotor currently is within a single revolution; that is, each and every pole position by unique PP number 302. It may determine if an illegal position is detected 304 and may report that to the Motor Position Control schemes 312. It also may account for where the rotor is within multiple revolutions in normal mode PP form across the entire range of machine operation 306. This process may include displaying the actual rotor position in operating units 308. It may determine how quickly the rotor gets from one pole position to the next 314 (by means of a clock 316) and may display this as angular velocity in operating units if required 310. This process may perform the above for all machine axes controlled by SR stepping.

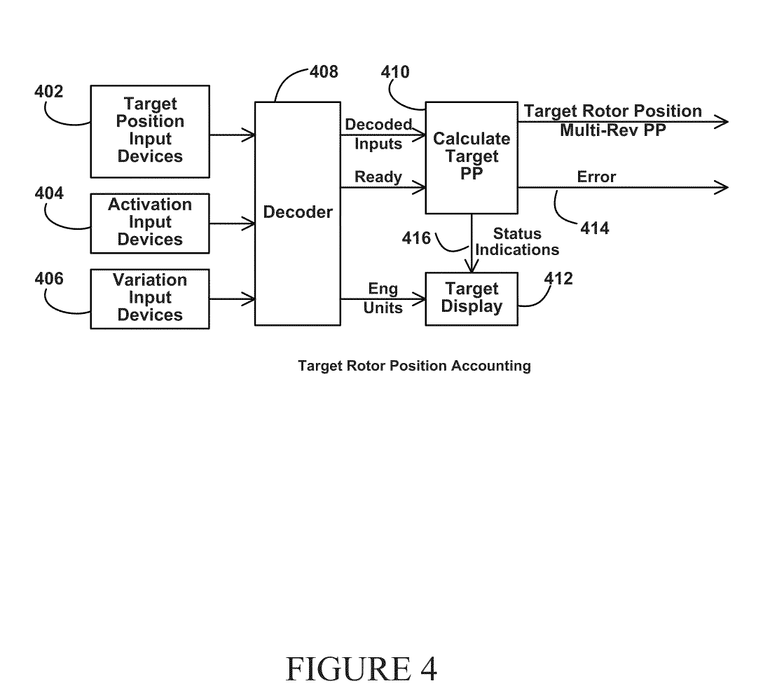

Function 2, the Target Rotor Position Accounting is shown in FIG. 4.

This process may detect the manual or automatic operation of target position input devices 402 (slider, knob, dial, retained position Joystick, touch screen, etc.). It may decode said inputs using, for example, a decoder 408. It also may detect the manual or automatic operation of activation input devices 404 (pushbutton, touch screen, etc.), and may decode said inputs using a decoder 408. This process may detect the manual or automatic operation of special variation input devices 406 (gain, vernier, etc.), and may decode said inputs using a decoder 408. It may account for the aggregate of all inputs using a computer or computational device 410, and it may convert the target position inputs into the normal mode multi-rev PP form. This process further may determine if an illegal target position or other errors 414 are detected and then may report those errors to the path calculation scheme. It may display the resulting target on the target display 412 in operating units and displays status indications 416 (i.e. Run/Stop) as required. This process may perform the above for all machine axes controlled by SR stepping.

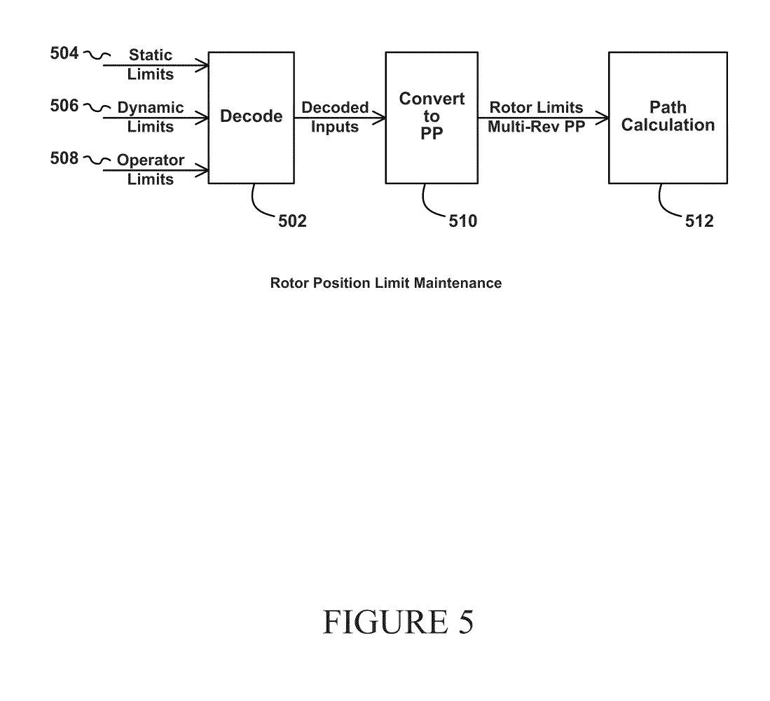

Function 3, the Rotor Position Limit Maintenance is shown in FIG. 5.

This process may input static 504, dynamic 506 or operator-set 508 limitations of rotor motion as a range of inclusion or exclusion (e.g. by means of a hardware or software device). This process may decode the limiting inputs 502 for PP conversion. It may convert the decoded limits 510 into the multi-rev normal mode PP form used as inputs to the path calculation 512. This process may perform the above for all machine axes controlled by SR stepping.

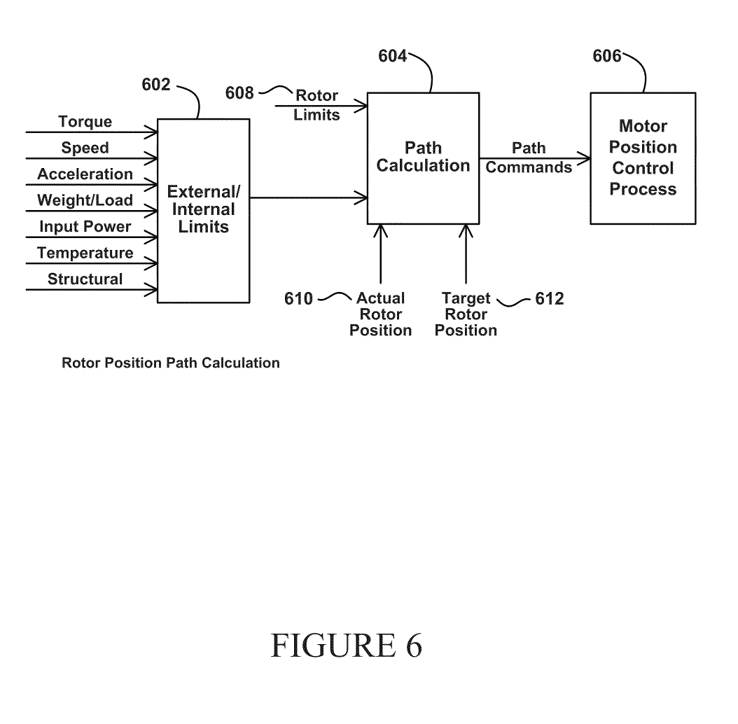

Function 4, the Rotor Position Path Calculation is shown in FIG. 6.

This process may calculate and optimize a machine path 604 for every movement, dictated by the actual 610 and target 612 rotor positions, and, for example, limited by the rotor position limits 608 as described in FIG. 5 (e.g. by means of a hardware or software device). This function may incorporate all the external and internal limits 602 of the hardware apparatus, including motor and machine characteristics like torque and speed, input power capabilities, operating temperature constraints, mechanical structure, system load, and allowable rates of change like acceleration/deceleration of the total system, etc. (e.g. by means of hardware or software devices). This process may output path commands to the motor position control process 606 in the required command format (e.g. by means of hardware or software devices).

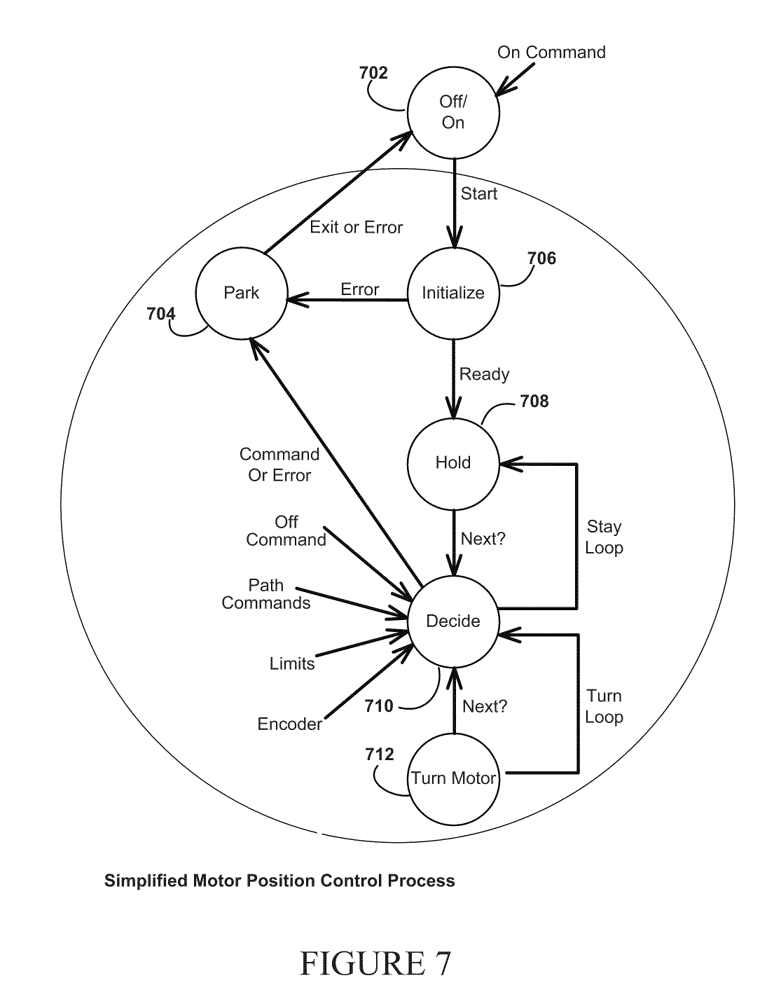

Function 5, the Motor Position Control is shown in FIG. 7. Motor position control may be implemented as a stored program that executes much more quickly than the time required to move the rotor from one pole position to the next. The Motor Position Control process may be defined in a series of steps. Moving the motor one pole position in either direction may require exactly one pass through the Turn Motor loop 712.

On/Off 702 may be the process that receives the external commands (via an operator or some automatic or remote means) to start or stop the system. When Start occurs, the system may go through an Initialization 706 process, readying the system of operation. The result may be an Error condition which may result in returning to a Park 704 state. Alternatively, if the Initialization 706 confirms the system is ready, the motor may go into a Hold condition 708.

Holding the motor at the current pole position may require executing the Hold process 708 just once. It may be the default state of the Motor Position Control. It may cause the motor to be energized at one pole position with sufficient torque to hold the maximum load. If entering Hold 708 from Initialization 706, the next process may immediately be Decide 710. Errors that occur during the initial Hold process may be reported to the Decide process for proper responses. If no errors are present, the Decide process 710 may always result in either Hold 708 or Turn Motor 712. Decide may include a number of operations and inputs. Commands may go to the Decide process 710 from path calculation logic (FIG. 6) 604 which determine direction, torque, speed, acceleration and deceleration from and to the Hold condition. It may convert commands to incremental motor steps or holds the motor in place. The Decide process 710 may monitor the progress toward the commanded target position

A command to the Decide process can begin the Stop sequence with an Off command if at anytime the operator or some automatic control wants to stop the motor. When a command function inputs the Decide process 710 with an “off” command, an orderly shutdown may then initiated by the Decide process 710 function, which in turn may park the motor and shuts down the system.

Actual rotor positions from the encoder may be monitored by the Decide process 710 to verify un-commanded movement. Physical limits may be monitored by the Decide process 710 to ensure the control system is prohibited from working beyond those limits regardless of commands. The system may go to the Hold process when the target is reached and stops in the target position. Errors discovered by or during the Decide process 710 may cause the system to go into Park 704.

The Hold process 708 may be used to maintain a fixed rotor position in the face of varying machine dynamics. Hold may include a variety of operations. After the initial entry to the Hold step, every subsequent entry to the Hold process 708 may come from the Decide process 710. The loop from Decide 710 to Hold 708 and back to Decide 710 is called the Stay Loop. To maintain the currently held position, the Hold condition may be adjusted in torque or direction by the Decide process 710. Errors that occur during the Hold process may be reported to the Decide process for proper responses. The Decide process may return as often as needed to the Hold step.

The Turn Motor process 712 may be used to increment the rotor position one pole position in either direction at commanded torque and speed. The loop from Decide 710 to Turn Motor 712 and back to Decide 710 is called the Turn loop. The Turn loop may be executed repeatedly until the Decide process 710 sees the target position is reached. Errors that occur during the Turn Motor process may be reported to the Decide process for proper responses.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. An apparatus, comprising:
a first device including one or more switch reluctance (SR) motors, the one or more SR motors being capable of operating in a stepping control mode; and
a second device capable of providing precise position control for the first device, while the one or more SR motors are operating in the stepping control mode.

2. The apparatus of claim 1, wherein one or more pole position sensors and encoders record pole position information.

3. The apparatus of claim 1, wherein errors are recorded and handled.

4. The apparatus of claim 1, wherein an exact pole position in terms of revolutions made and a position within a specified revolution is calculated.

5. The apparatus of claim 1, wherein a target pole position is calculated by means of decoding various input devices.

6. The apparatus of claim 1, wherein a target pole position is displayed with status indications.

7. The apparatus of claim 1, wherein at least one of static, dynamic, or operator imposed limits are inputted to determine a valid path calculation.

8. The apparatus in claim 1, wherein at least one of external or internal system limits are calculated to input a path calculation for a final path command to a motor control process.

9. The apparatus of claim 1, wherein stepping of at least one of the one or more SR motors is controlled by a step-by-step decision making process.

10. The apparatus of claim 9, wherein a turn loop is activated to move at least one pole position.

11. The apparatus of claim 10, wherein the turn loop continues to a target pole position.

12. The apparatus of claim 9 wherein a stay loop activates a hold position.
